(19) United States
(12) Patent Application Publication
(10) Pub. No.: US 2011/0031966 A1
(43) Pub. Date: Feb. 10, 2011

(54) NON-CONTACT TYPE TRANSDUCER HAVING MULTI-LOOP COIL FOR PLATE MEMBER

(75) Inventors: Chan Il PARK, Gunpo Si (KR); Sun Ho LEE, Yongin Si (KR); Yoon Young KIM, Seoul (KR)

Correspondence Address: Jae Y. Park, Kile, Park, Goekjian, Reed & McManus, PLLC, 1200 New Hampshire Ave. NW, Suite 570, Washington, DC, 20036, US

(73) Assignee: SNU R&DB FOUNDATION, Seoul (KR)

(21) Appl. No.: 12/847,872

(22) Filed: Jul. 30, 2010

(30) Foreign Application Priority Data
Aug. 4, 2009 (KR) 10-2009-0071712

(51) Int. Cl. G01N 27/90

(52) U.S. Cl. 324/240

(57) ABSTRACT

A non-contact type transducer having a multi-loop coil that is used to perform a modal test or a nondestructive inspection on a plate member without contacting the plate member is disclosed. The transducer includes a multi-loop coil having two or more closed loop portions and disposed above and separate from a plate member; and a magnet having a neutral plane between north (N) and south (S) poles parallel to a surface of the plate member and functioning as a static magnetic field former, wherein the plate member is formed of a conductor, wherein an eddy current that flows on a surface of the plate member is generated by controlling a current that flows through the multi-loop coil, and Lorentz forces are applied in directions perpendicular to the surface of the plate member due to the eddy current and a magnetic field component parallel to the surface of the plate member of a static magnetic field formed by the static magnetic field former.

### CROSS-REFERENCE TO RELATED PATENT APPLICATION

This application claims the benefit of Korean Patent Application No. 10-2009-0071712, filed on Aug. 4, 2009, in the Korean Intellectual Property Office, the disclosure of which is incorporated herein in its entirety by reference.

### BACKGROUND OF THE INVENTION

1. Field of the Invention

The present invention relates to a transducer for performing a modal test or a nondestructive inspection on a plate member, and more particularly, to a non-contact type transducer having a multi-loop coil that excites a plate member, i.e., a test target, by using the multi-loop coil without contacting the plate member or diagnoses a structure by measuring a signal transmitted on the excited plate member.

The present invention was supported by the new technology research and development program of the Korea Science and Engineering Foundation (KOSEF) and the Seoul National University Research & Development Business Foundation (SNU R&DB Foundation).

[2009-0083279, Multi-Scale Paradigm for Creative Design of Multi-Physical Complex Structure System]

2. Description of the Related Art

When mechanical devices are designed or inspected, in many cases, a modal test may be performed to check their structural stability. Information such as a natural frequency and a mode shape may be obtained by performing a modal test, and resonance damages, wear, etc. of a mechanical device, which occur due to vibration caused when the mechanical device operates, may be prevented by reflecting the information in the design of the machine device. Thus, the structural stability of the mechanical device may be achieved.

In a modal test for checking vibration properties of an element of a mechanical device, the element, i.e., a test target has to be excited and the vibration of the element has to be measured.

FIG. 1 is a schematic diagram for describing a conventional method of performing a modal test on a plate member 502.

Referring to FIG. 1, in the conventional method, a person generally excites the plate member 502, i.e., a test target, by using an impact hammer 80. Also, a commercial acceleration sensor 700 is attached on the test target in order to measure a signal transmitted by the excited test target. However, in this case, repeated reproducibility of the test may not be ensured.

Accordingly, the development of a method and apparatus for uniformly exciting a plate member, i.e., a test target, in a modal test and measuring the vibration of the plate member is greatly required.

Also, in addition to a modal test, when a mechanical element is structurally diagnosed by performing, for example, a nondestructive inspection, the nondestructive inspection may not be easily performed without contacting the mechanical element. In particular, since structural diagnosis may not be performed easily on an already-assembled mechanical element due to interferences of other mechanical elements, the mechanical element may have to be first disassembled to perform a nondestructive inspection.

Accordingly, the development of a simple transducer for structurally diagnosing a plate member is greatly required.

### SUMMARY OF THE INVENTION

The present invention provides a non-contact type transducer having a multi-loop coil that simply performs a modal test or a nondestructive inspection on a plate member without contacting the plate member.

According to an aspect of the present invention, there is provided a transducer including a multi-loop coil having two or more closed loop portions and disposed above and separate from a plate member; and a magnet having a neutral plane between north (N) and south (S) poles parallel to a surface of the plate member and functioning as a static magnetic field former, wherein the plate member is formed of a conductor, wherein an eddy current that flows on a surface of the plate member is generated by controlling a current that flows through the multi-loop coil, and Lorentz forces are applied in directions perpendicular to the surface of the plate member due to the eddy current and a magnetic field component parallel to the surface of the plate member of a static magnetic field formed by the static magnetic field former, and wherein an eddy current is generated on regions of the plate member below a magnetic field component parallel to the surface of the plate member of a static magnetic field formed by the static magnetic field former when vibration is transmitted on the plate member, and an electromotive force is generated on the multi-loop coil so that a magnetic field component is formed in a direction opposite to a direction of a magnetic field component formed due to the eddy current in order to offset the magnetic field component formed due to the eddy current, and the vibration transmitted on the plate member is measured from the electromotive force.

According to another aspect of the present invention, there is provided a transducer including a multi-loop coil having two or more closed loop portions and disposed above and separate from a plate member; a magnet having a neutral plane between north (N) and south (S) poles parallel to a surface of the plate member and functioning as a static magnetic field former; and conductor foil attached on the plate member so as to cover a surface portion of the plate member facing the multi-loop coil, wherein an eddy current that flows on a surface of the conductor foil is generated by controlling a current that flows through the multi-loop coil, and Lorentz forces are applied in directions perpendicular to the surface of the plate member due to the eddy current and a magnetic field component parallel to the surface of the plate member of a static magnetic field formed by the static magnetic field former, and wherein an eddy current is generated on the conductor foil contacting regions of the plate member below a magnetic field component parallel to the surface of the plate member of a static magnetic field formed by the static magnetic field former when vibration is transmitted on the plate member, and an electromotive force is generated on the multi-loop coil so that a magnetic field component is formed in a direction opposite to a direction of a magnetic field component formed due to the eddy current in order to offset the magnetic field component formed due to the eddy current, and the vibration transmitted on the plate member is measured from the electromotive force.

Here, the multi-loop coil may be a figure-of-8 type coil having two closed loop portions, the two closed loop portions may be disposed in a row above the plate member and parallel to the surface of the plate member, and the two closed loop portions may have different coiling directions.

Here, the multi-loop coil may have an odd number of closed loop portions, an even number of side closed loop portions may be symmetrically disposed with respect to one center closed loop portion, and a coiling direction of the center closed loop portion may be different from the coiling direction of the side closed loop portions.

Here, the magnet may be disposed in a middle of the center closed loop portion and separate from the plate member, and the neutral plane of the magnet may be parallel to the surface of the plate member.

Here, the multi-loop coil may include a coil in which figure-of-8 type coils each having two closed loop portions are disposed to cross each other, the two closed loop portions of each of the figure-of-8 type coils may be disposed in a row above the plate member and parallel to the surface of the plate member, and the two closed loop portions of each of the figure-of-8 type coils may have different coiling directions.

Here, the static magnetic field may be formed by disposing two or more magnets in a parallel direction to the surface of the plate member with different poles of the magnet facing each other above the plate member.

According to another aspect of the present invention, there is provided a transducer including a multi-loop coil having two or more closed loop portions and disposed above and separate from a plate member; and a power source for applying a variable current signal to the multi-loop coil, wherein the plate member is formed of a conductor, and wherein an eddy current that flows on a surface of the plate member is generated by controlling a current that flows through the multi-loop coil, and Lorentz forces are applied in directions perpendicular to the surface of the plate member due to the eddy current and a magnetic field component parallel to the surface of the plate member of a static magnetic field formed by the static magnetic field former.

According to another aspect of the present invention, there is provided a transducer including a multi-loop coil having two or more closed loop portions and disposed above and separate from a plate member; a power source for applying a variable current signal to the multi-loop coil; and conductor foil attached on the plate member so as to cover a surface portion of the plate member facing the multi-loop coil, wherein an eddy current that flows on a surface of the conductor foil is generated by controlling a current that flows through the multi-loop coil, and Lorentz forces are applied in directions perpendicular to the surface of the plate member due to the eddy current and a magnetic field component parallel to the surface of the plate member of a static magnetic field formed by the static magnetic field former.

Here, the multi-loop coil may be a figure-of-8 type coil having two closed loop portions, the two closed loop portions may be disposed in a row above the plate member and parallel to the surface of the plate member, and the two closed loop portions may have different coiling directions.

Here, the multi-loop coil may have an odd number of closed loop portions, an even number of side closed loop portions may be symmetrically disposed with respect to one center closed loop portion, and a coiling direction of the center closed loop portion may be different from the coiling direction of the side closed loop portions.

Here, the multi-loop coil may include a coil in which figure-of-8 type coils each having two closed loop portions are disposed to cross each other, the two closed loop portions of each of the figure-of-8 type coils may be disposed in a row above the plate member and parallel to the surface of the plate member, and the two closed loop portions of each of the figure-of-8 type coils may have different coiling directions.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic diagram for describing a conventional method of performing a modal test on a plate member;

FIG. 2 is a schematic diagram for describing a method of performing a modal test on a plate member by using a transducer as an exciter (actuator), according to an embodiment of the present invention;

FIG. 3 is a detailed perspective view of the transducer illustrated in FIG. 2;

FIG. 4 is a plan view of the transducer illustrated in FIG. 3;

FIG. 5 is a side view of the transducer illustrated in FIG. 3 for describing the operating principle of the transducer;

FIG. 6 is a diagram for describing a method of coiling a multi-loop coil used in the transducer illustrated in FIG. 3;

FIG. 7 is a plan view of a transducer, according to another embodiment of the present invention;

FIGS. 8 and 10 are graphs of frequency response functions obtained by performing a modal test on an aluminum plate by using an impact hammer and an acceleration sensor;

FIGS. 9 and 11 are graphs of frequency response functions obtained by performing a modal test on an aluminum plate by using an acceleration sensor and the transducer illustrated in FIG. 3;

FIG. 12 is a schematic diagram of a transducer, according to another embodiment of the present invention;

FIG. 14 is a schematic diagram of a transducer, according to another embodiment of the present invention;

FIG. 15 is a side view of the transducer illustrated in FIG. 14;

FIG. 17 is a schematic diagram of a transducer, according to another embodiment of the present invention;

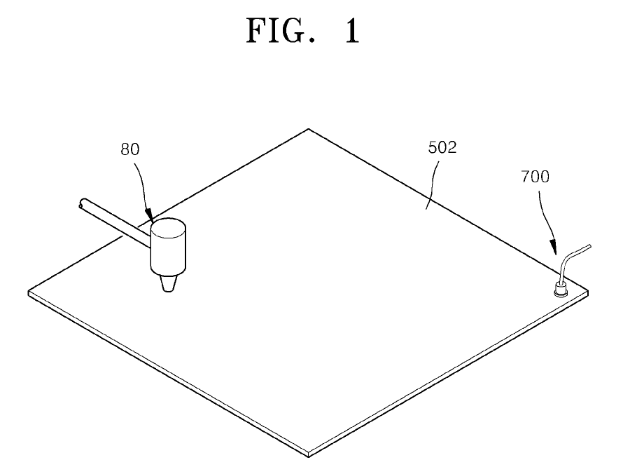

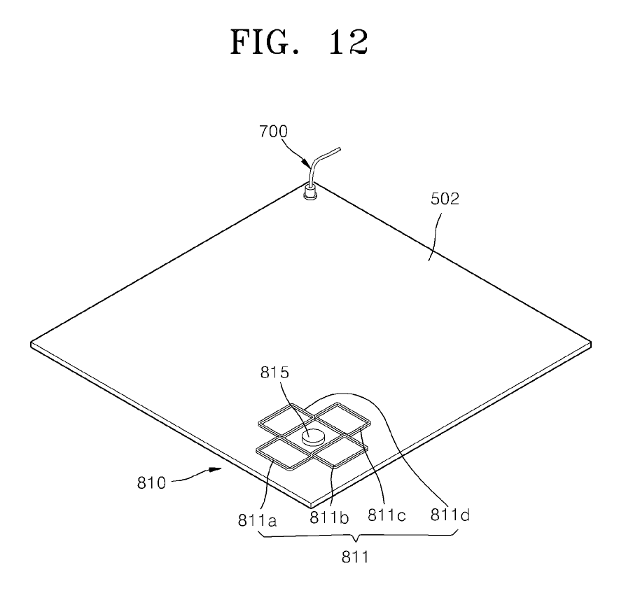

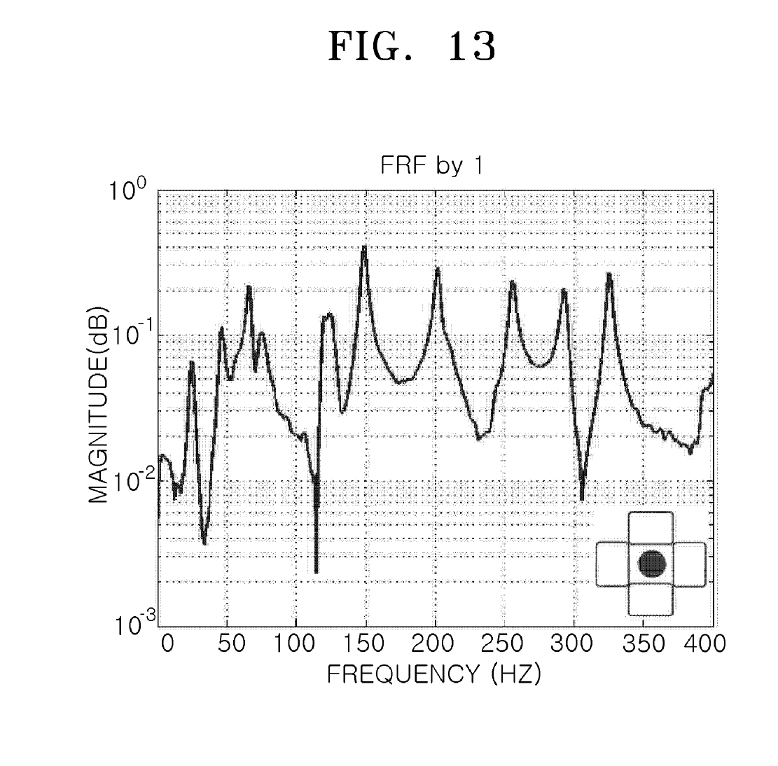

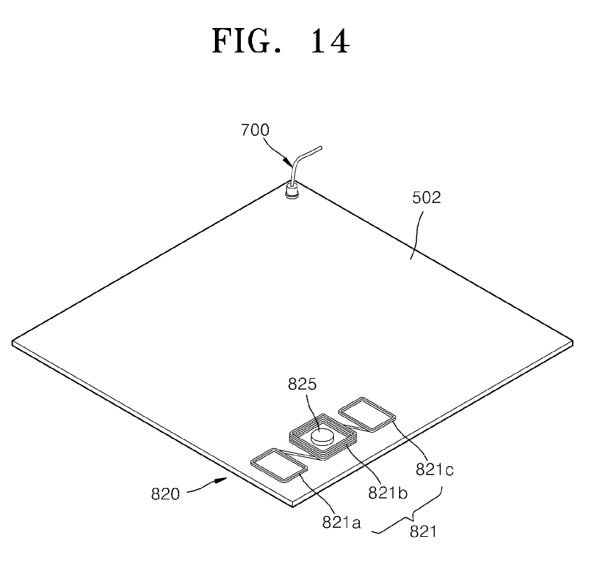

FIGS. 13, 16 and 18 are graphs of frequency response functions obtained by performing a modal test by using an acceleration sensor and using the transducers illustrated in FIGS. 12, 14 and 17 as exciters (actuators), respectively;

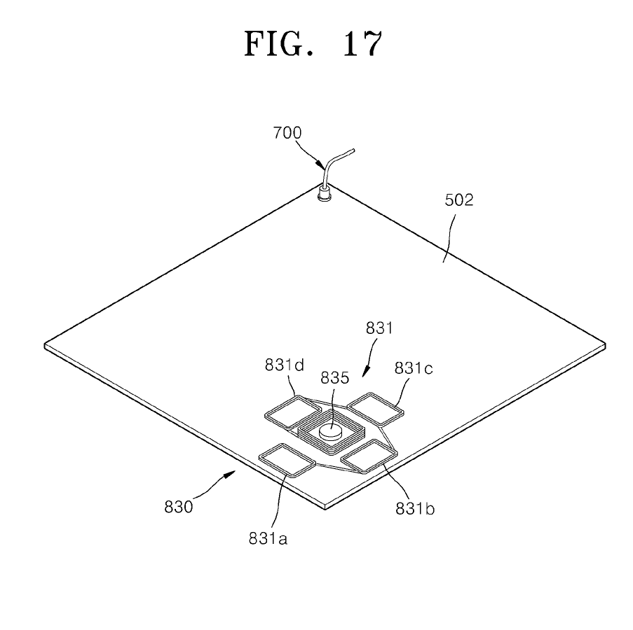

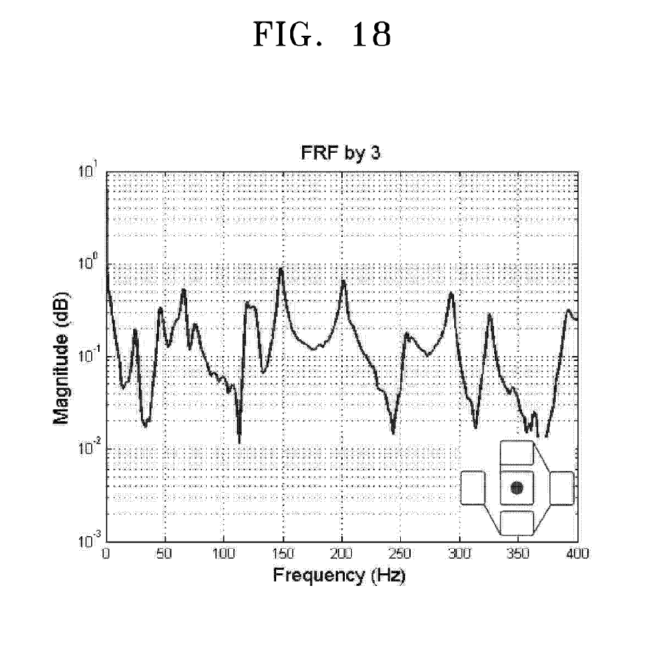

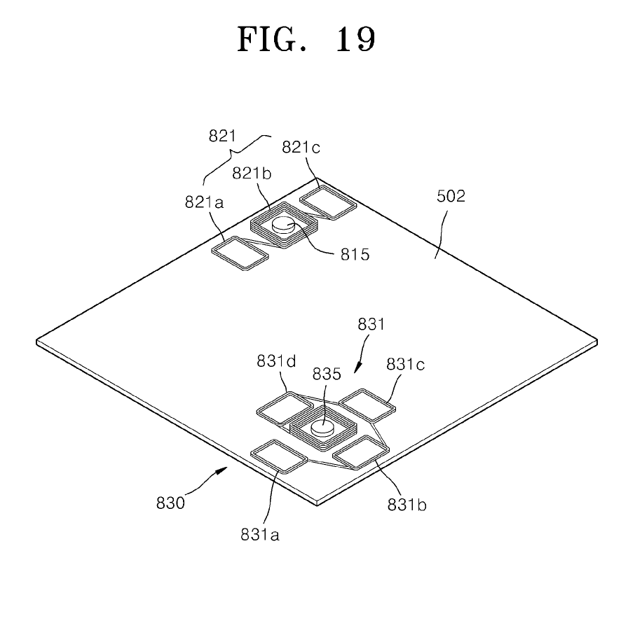

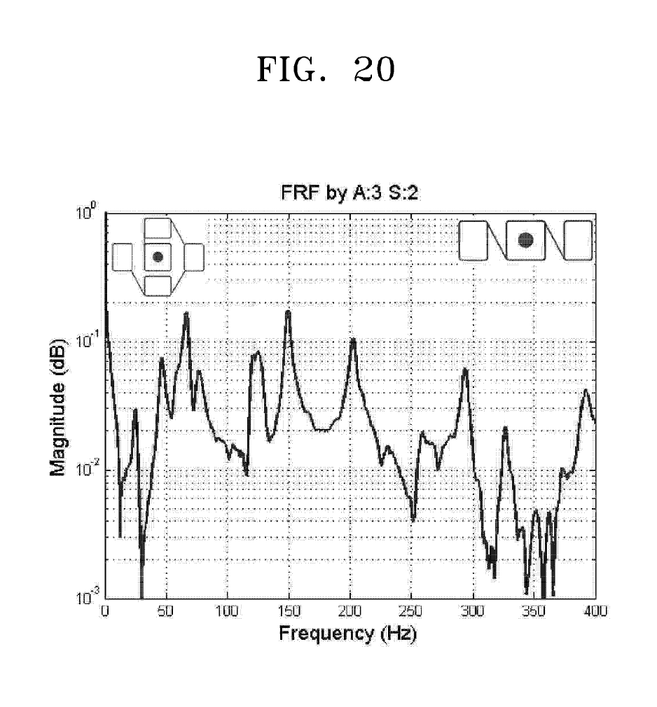

FIG. 19 is a schematic view when a modal test is performed by using the transducer illustrated in FIG. 17 as an exciter (actuator) and using the transducer illustrated in FIG. 14 as a sensor; and

FIG. 20 is a graph of a frequency response function when a modal test is performed as illustrated in FIG. 19.

### DETAILED DESCRIPTION OF THE INVENTION

Hereinafter, the present invention will be described in detail by explaining embodiments of the invention with reference to the attached drawings.

A multi-loop coil used in the present invention is a coil that has two or more closed loop portions that are electrically connected. Also, the closed loop portions may have different coiling directions (clockwise and counterclockwise directions) and thus magnetic fields formed by the closed loop portions when a current flows through the multi-loop coil may have different directions.

A transducer used in the present invention is a transducer that excites a metal plate member having electric conductivity without contacting the plate member or measures vibrations transmitted on the plate member, and relates to an electromagnetic acoustic transducer (EMAT), which uses the principles of electromagnetic induction and Lorentz force.

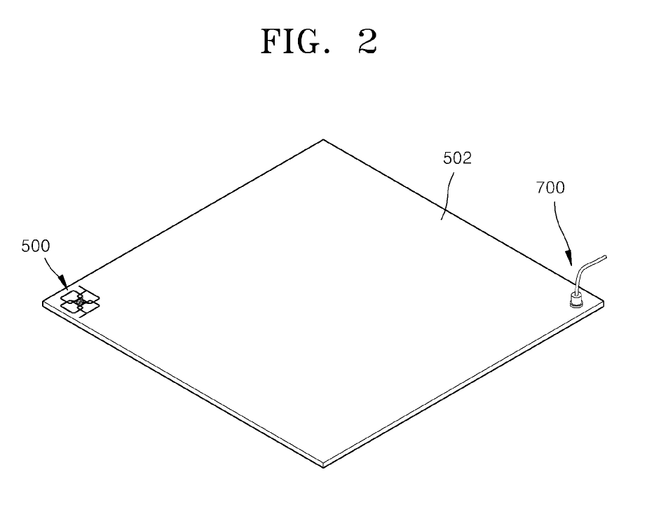

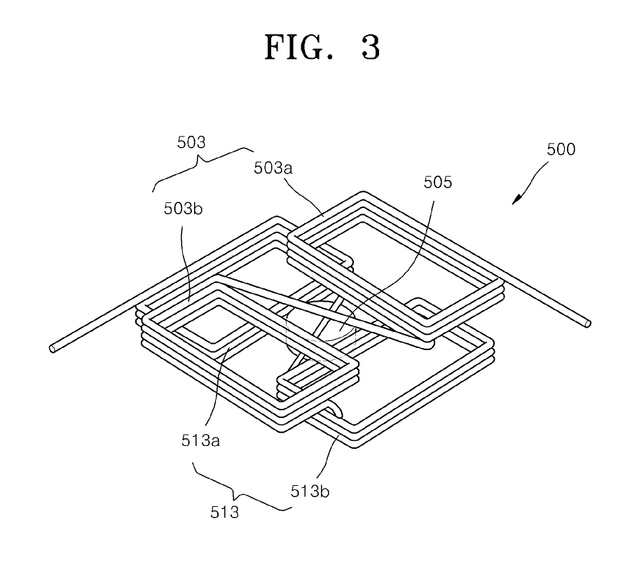

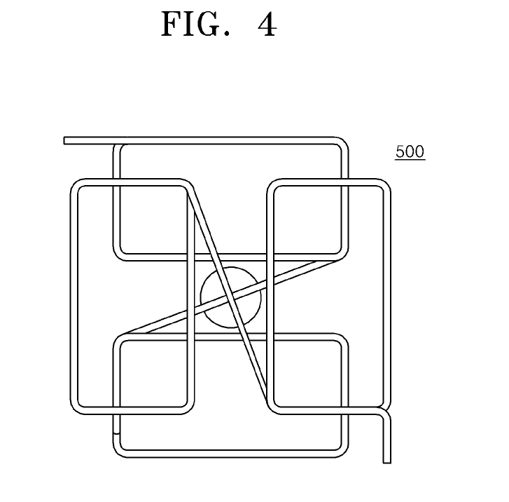

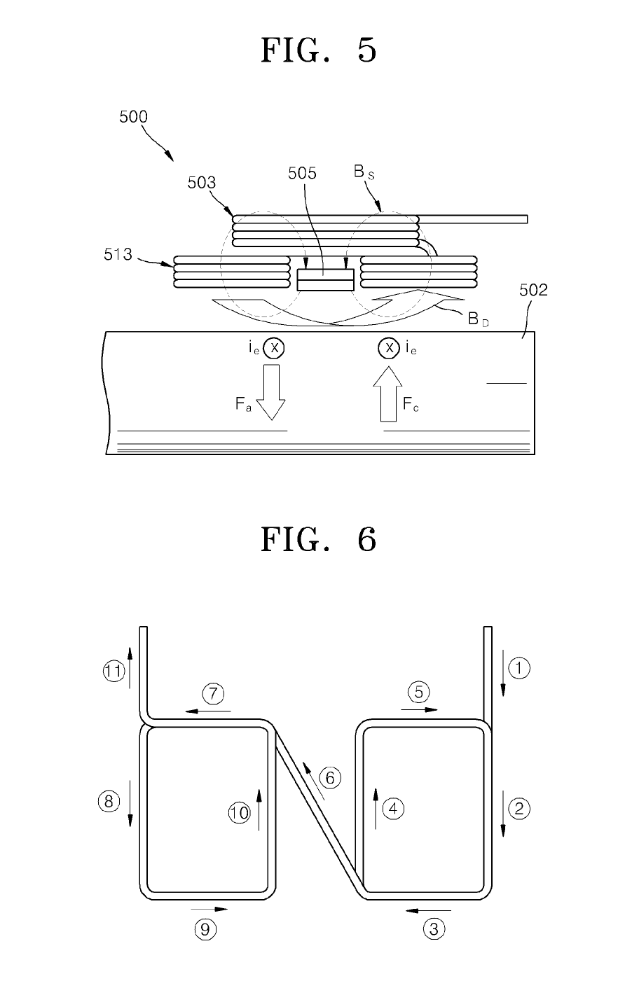

FIG. 2 is a schematic diagram for describing a method of performing a modal test on a plate member 502 by using a transducer 500 as an exciter (actuator), according to an embodiment of the present invention. FIG. 3 is a detailed perspective view of the transducer 500 illustrated in FIG. 2. FIG. 4 is a plan view of the transducer 500 illustrated in FIG. 3. FIG. 5 is a side view of the transducer 500 illustrated in FIG. 3 for describing the operating principle of the transducer 500.

Referring to FIGS. 3 through 5, the transducer 500 includes a magnet 505 disposed adjacent to the plate member 502, and two multi-loop coils 503 and 513.

The magnet 505 may be a permanent magnet or an electromagnet. A neutral plane between north (N) and south (S) poles of the magnet 505 is parallel to a surface of the plate member 502 and thus a static magnetic field B_{S} is formed near the plate member 502 as represented by dashed arrows illustrated in FIG. 5. There exits a_component of the static magnetic field B_{S} having a direction parallel to the surface of the plate member 502 around a region of the plate member 502 below not the magnet 505 but the multi-loop coils 503 and 513. FIG. 5 being a side view, we can see only the component of the static magnetic field B_{S} having a direction parallel to the surface of the plate member 502 just below the multi-loop coil 503.

The multi-loop coils 503 and 513 are figure-of-8 type coils respectively having two closed loop portions 503a and 503b and two closed loop portions 513a and 513b. The closed loop portions 503a, 503b, 513a and 513b of the multi-loop coils 503 and 513 may have the same size. Virtual lines respectively between the centers of the closed loop portions 503a and 503b and between the centers of the closed loop portions 513a and 513b of the multi-loop coil 503 or 513 are defined as length direction lines of the multi-loop coils 503 and 513, and the multi-loop coils 503 and 513 are arranged such that the length direction lines of the multi-loop coils 503 and 513 cross each other. An angle formed between the length direction lines of the multi-loop coils 503 and 513 may be a right angle so that vibration may be evenly transmitted on the plate member 502 two-dimensionally.

FIG. 6 is a diagram for describing a method of coiling a multi-loop coil used in the transducer 500 illustrated in FIG. 3.

Referring to FIG. 6, if one closed loop portion of the multi-loop coil is coiled in the order of \textcircled{1}, \textcircled{2}, \textcircled{3}, \textcircled{4} and \textcircled{5} in a clockwise direction, another closed loop portion of the multi-loop coil is coiled in the order of \textcircled{6}, \textcircled{7}, \textcircled{8}, \textcircled{9}, \textcircled{10} and \textcircled{11} in a counterclockwise direction. In this case, if a current flows as represented by arrows illustrated in FIG. 6, magnetic fields formed by the closed loop portions have different directions. In more detail, a magnetic field is formed in a direction perpendicularly into the surface of FIG. 6 in a right closed loop portion and a magnetic field is formed in a direction perpendicularly out of the surface of FIG. 6 in a left closed loop portion. As a result, magnetic fields are formed around the multi-loop coil in a circular direction from the inside of the one closed loop portion to the inside of the other closed loop portion.

The operating principle of the transducer 500 as a transmitter will now be described.

Referring to FIG. 5, a magnetic field component B_{D} having a direction parallel to the surface of the plate member 502 is formed on the plate member 502 and under the multi-loop coil 513, that is, a lower multi-loop coil. In this case, if a current that flows through the multi-loop coil 513 varies, the magnetic field component B_{D} formed by the multi-loop coils 503 and 513 varies. If the magnetic field component B_{D} varies, due to electromagnetic induction, an electromotive force is generated in a direction countering the variation of the magnetic field component B_{D}. For example, if the current that flows through the multi-loop coil 513 is reduced, the magnetic field component B_{D} is reduced and thus an eddy current iₑ is formed on the surface of the plate member 502 in order to compensate for the reduction of the magnetic field component B_{D}. That is, the eddy current iₑ flows on the surface of the plate member 502 in a direction into the surface of FIG. 5. If the eddy current iₑ is formed, the static magnetic field B_{S} formed by the magnet 505 applies forces Fₐ and F_{c}, i.e., Lorentz forces, on the plate member 502. Since the forces Fₐ and F_{c} act as impact forces on the plate member 502, if the current that flows through the multi-loop coil 513 is controlled, due to the impact forces, which act in directions perpendicular to the surface of the plate member 502, wave vibrating in a direction perpendicular to the plate member 502 (a direction of parallel to z-axis) may propagate on the plate member 502. If a current that flows through one multi-loop coil is controlled, vibrations are generated and transmitted mostly in a direction parallel to a length direction between two closed loop portions of the multi-loop coil.

Likewise, if currents that flow through the two multi-loop coils 503 and 513 are controlled, waves vibrating in a direction perpendicular to the plate member 502 may propagate on the plate member 502 and be transmitted mostly in directions perpendicular to each other. Thus, the transducer 500 may generate waves and two-dimensionally transmit the waves on the plate member 502 in directions perpendicular to each other, and may be used as an actuator to perform a modal test on the plate member 502 or to detect errors of the plate member 502.

In a conventional method of performing a modal test on a plate member by using an impact hammer, an impact has to be directly applied to the plate member. Thus, for example, if the plate member is covered by a thermal insulator or if the plate member may not be easily accessed due to interference of another element, a mechanical device may have to be disassembled to perform a modal test. Also, since a person applies impact forces by using the impact hammer, the impact forces may not be uniformly generated and thus a modal test may have to be repeatedly performed.

However, the transducer 500 according to the current embodiment does not need to contact the plate member 502 to excite the plate member and thus a modal test may be performed without having to disassemble a mechanical device. Also, since a force to be applied may be finely controlled, a modal test may not need to be repeatedly performed. Although a modal test may be repeatedly performed on a plurality of regions of the plate member 502, the transducer 500 may be easily moved and may easily excite the plate member 502.

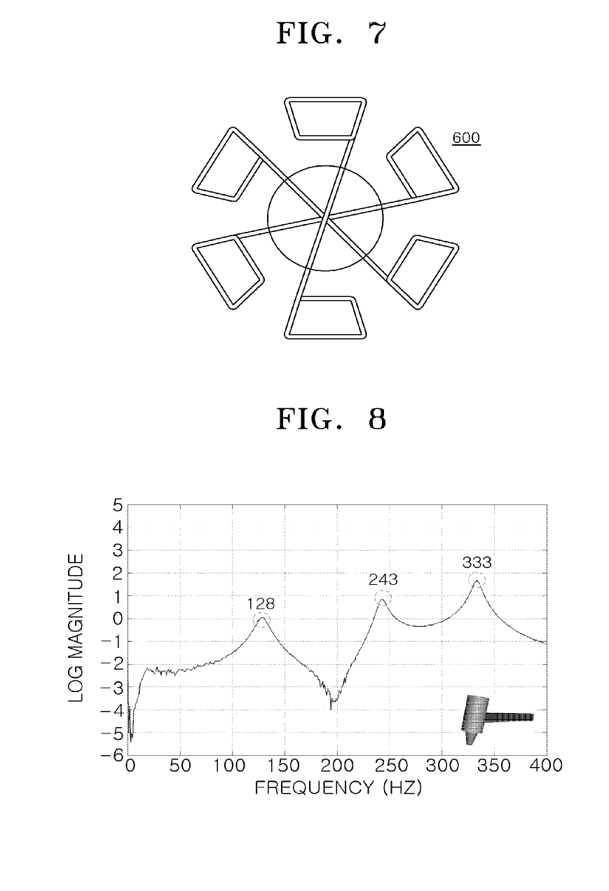

FIG. 7 is a plan view of a transducer 600, according to another embodiment of the present invention.

Referring to FIG. 7, the transducer 600 includes three figure-of-8 type multi-loop coils each having two closed loop portions. The closed loop portions are formed in a fan shape and thus the three multi-loop coils may overlap. If the three multi-loop coils are used as described above, waves vibrating in a direction perpendicular to the plate member 502 may propagate on the plate member 502 in three different directions. For more precise measurement, a transducer for performing a modal test on a plate member may be manufactured by forming closed loop portions of four or more multi-loop coils in a fan shape.

The performance of the transducer 500 illustrated in FIG. 3 will now be described with reference to test results.

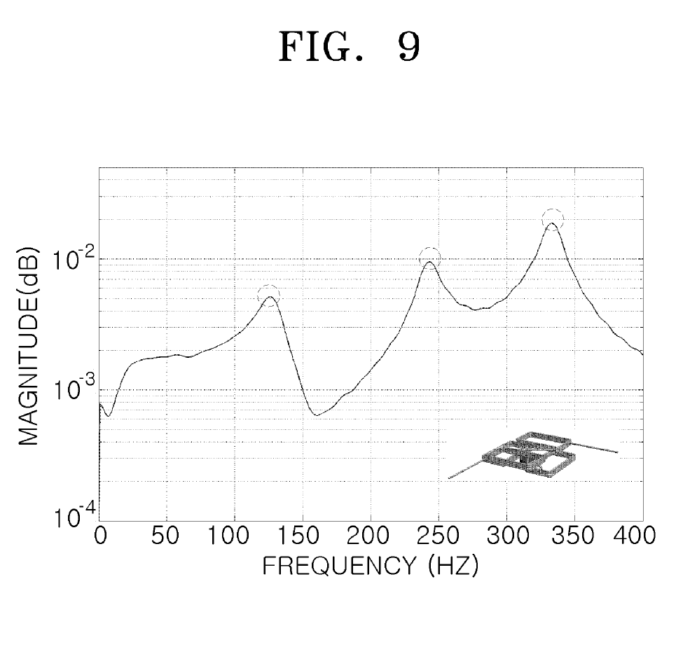

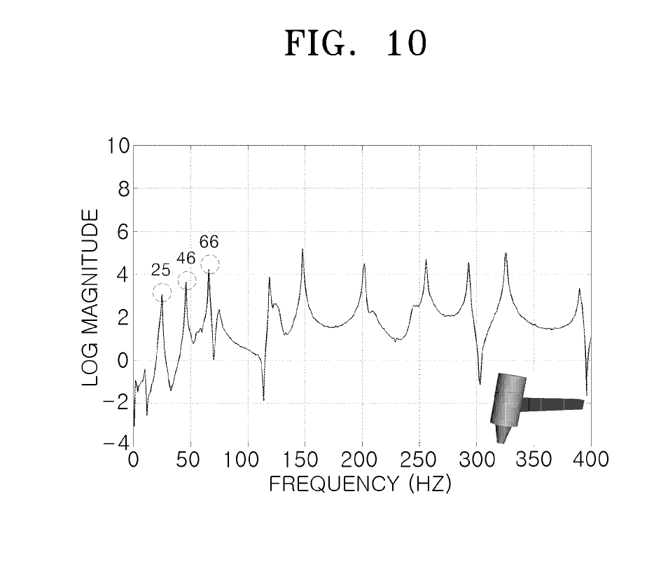

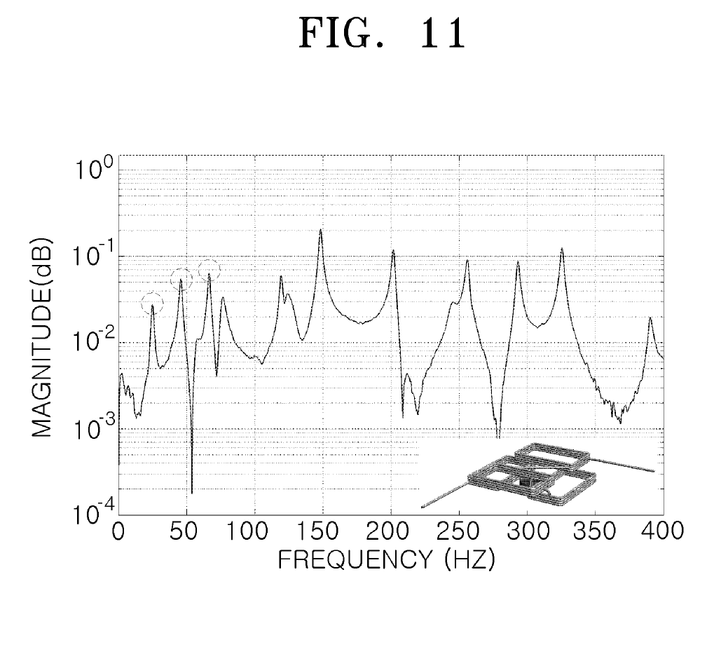

FIGS. 8 and 10 are graphs of frequency response functions obtained by performing a modal test on an aluminum plate by using an impact hammer and an acceleration sensor. FIGS. 9 and 11 are graphs of frequency response functions obtained by performing a modal test on an aluminum plate by using an acceleration sensor and the transducer 500 illustrated in FIG. 3. FIGS. 8 and 9 show results when a modal test is performed on an aluminum plate that is 500 mm in width and length and 10 mm in thickness, and FIGS. 10 and 11 show results when a modal test is performed on an aluminum plate that is 500 mm in width and length and 2 mm in thickness.

Theoretically, natural frequencies of the aluminum plate that is 500 mm in width and length and 10 mm in thickness are 126 Hz, 241 Hz and 321 Hz. Natural frequencies of 128 Hz, 243 Hz and 333 Hz are measured in FIG. 8 and natural frequencies of 125 Hz, 242 Hz and 333 Hz are measured in FIG. 9. The results show no problems in using the transducer 500 instead of an impact hammer as an actuator to perform a modal test on a plate member.

Also, theoretically, natural frequencies of the aluminum plate that is 500 mm in width and length and 2 mm in thickness are 25.9 Hz, 48.1 Hz and 67.4 Hz. Natural frequencies of 25 Hz, 46 Hz and 66 Hz are measured in FIG. 10 and natural frequencies of 25 Hz, 45 Hz and 66 Hz are measured in FIG. 11. The results also show no problems in using the transducer 500 instead of an impact hammer as an actuator to perform a modal test on a plate member.

FIG. 12 is a schematic diagram of a transducer 810, according to another embodiment of the present invention.

Referring to FIG. 12, the transducer 810 includes a magnet 815 for forming a static magnetic field, and a multi-loop coil 811 having four closed loop portions 811a, 811b, 811c and 811d around the magnet 815.

The magnet 815 has a neutral plane between N and S poles parallel to a surface of the plate member 502 and separate from the plate member 502 by a predetermined distance. A magnetic field component that is formed around the magnet 815 and is parallel to the surface of the plate member 502 influences operation of the transducer 810.

Every two opposite closed loop portions with reference to the magnet 815 from among the four closed loop portions 811a, 811b, 811c and 811d of the multi-loop coil 811 have different coiling directions. That is, the closed loop portions 811a and 811c have different coiling directions, and the closed loop portions 811b and 811d also have different coiling directions. Accordingly, as described above with reference to FIG. 5, forces act in opposite directions perpendicular to the surface of the plate member 502 around a region of the plate member 502 directly below the magnet 815. As a result, forces act in directions perpendicular to the surface of the plate member 502 on four regions separated by a predetermined distance from the region of the plate member 502 facing the magnet 815, toward the four closed loop portions 811a, 811b, 811c and 811d. The forces on the four regions have the same magnitude and each two opposite forces act in opposite directions.

FIG. 13 is a graph of a frequency response function obtained by performing a modal test by using a general acceleration sensor and the transducer 810 illustrated in FIG. 12 as an actuator. As in FIGS. 10 and 11, the modal test is also performed on an aluminum plate that is 500 mm in width and length and 2 mm in thickness. As illustrated in FIG. 13, natural frequencies of 25 Hz, 48 Hz and 67 Hz are measured in a low frequency region. As shown in the results of FIGS. 8 through 11, the transducer 810 may also be used as an actuator for exciting a plate member.

FIG. 14 is a schematic diagram of a transducer 820, according to another embodiment of the present invention.

Referring to FIG. 14, the transducer 820 includes a multi-loop coil 821 having a center closed loop portion 821b and two side closed loop portions 821a and 821c disposed at two opposite sides of the center closed loop portion 821b so as to function as a dynamic magnetic field former, and a magnet 825 disposed in the middle of the center closed loop portion 821b of the multi-loop coil 821 so as to function as a static magnetic field former.

The magnet 825 is identical to the magnet 505 or 815 illustrated in FIG. 3 or 12, and is disposed identically.

The center closed loop portion 821b of the multi-loop coil 821 has a coiling direction different from that of the side closed loop portions 821a and 821c.

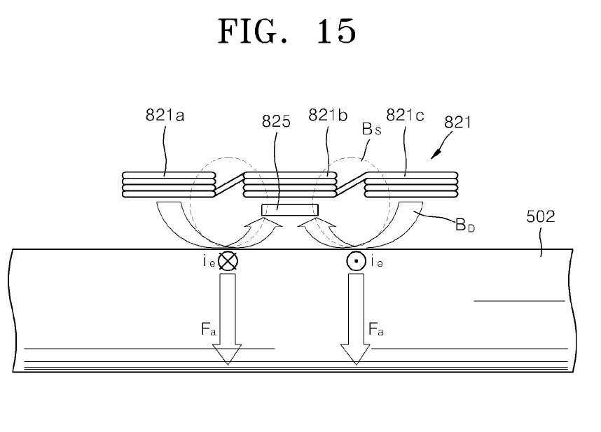

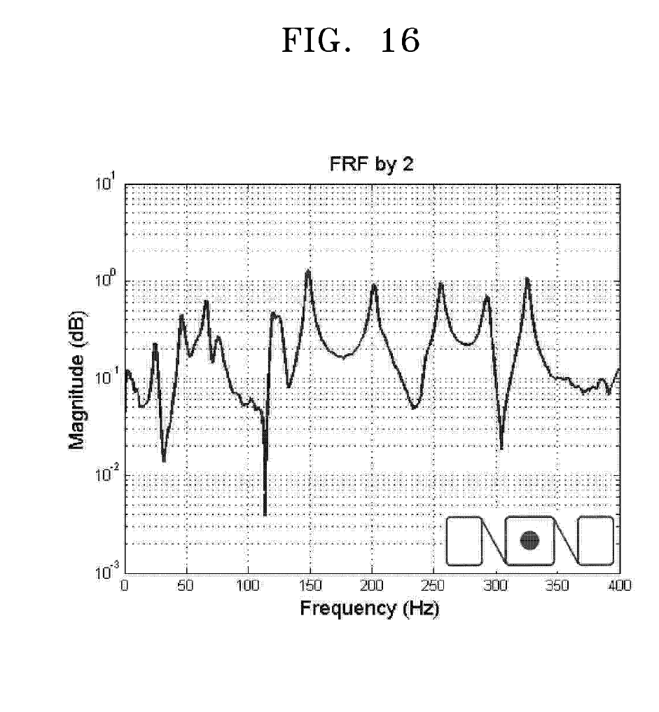

FIG. 15 is a side view of the transducer 820 illustrated in FIG. 14.

Referring to FIG. 15, since a coiling direction of the center closed loop portion 821b is different from that of the side closed loop portions 821a and 821c, a magnetic field component B_{D} may be formed by the multi-loop coil 821 as represented by thick arrows. In FIG. 15, the coiling direction of the center closed loop portion 821b is a counterclockwise direction and the coiling direction of the side closed loop portions 821a and 821c is a clockwise direction. A static magnetic field B_{S} may be formed by the magnet 825 as represented by dashed arrows.

In this case, if the size of the magnetic field component B_{D} formed by the dynamic magnetic field former is varied by controlling a current that flows through the multi-loop coil 821, in order to compensate for the variation of the magnetic field component B_{D}, an eddy current iₑ that flows on the surface of the plate member 502 is formed on regions at two sides of a region of the plate member 502 below the center closed loop portion 821b. Due to the eddy current iₑ and the static magnetic field B_{S} formed by the magnet 825, according to the principal of Lorentz force, a force Fₐ that is perpendicular to the eddy current iₑ acts on the regions of the plate member 502 where the eddy current iₑ flows. The force Fₐ acts in the same direction on the regions separated from the region of the plate member 502 facing the magnet 825, toward the side closed loop portions 821a and 821c. While FIGS. 3, 7 and 12 illustrate a multi-loop coil having an even number of closed loop portions, FIGS. 14 and 15 illustrate a multi-loop coil having three closed loop portions. In comparison to an even number of closed loop portions, a difference of having three closed loop portions instead is the direction of forces. That is, in FIGS. 14 and 15, forces at two sides of a magnet act in the same direction.

FIG. 17 is a schematic diagram of a transducer 830, according to another embodiment of the present invention.

Referring to FIG. 17, the transducer 830 includes a multi-loop coil 831 having a center closed loop portion and four side closed loop portions 831a, 831b, 831c and 831d disposed at four sides of the center closed loop portion, and a magnet 835 for forming a static magnetic field.

A difference between FIGS. 14 and 17 is that the multi-loop coil 821 illustrated in FIG. 14 has three closed loop portions and the multi-loop coil 831 illustrated in FIG. 17 has five closed loop portions. In FIG. 17, the side closed loop portions 831a, 831b, 831c and 831d are disposed at four sides of the center closed loop portion at equal intervals from the center closed loop portion. A coiling direction of the center closed loop portion is different from that of the side closed loop portions 831a, 831b, 831c and 831d and thus a direction of a magnetic field formed around the center closed loop portion is different from that of magnetic fields formed around the side closed loop portions 831a, 831b, 831c and 831d when a current flows through the multi-loop coil 831. That is, the magnetic fields formed around the side closed loop portions 831a, 831b, 831c and 831d have the same direction. The magnet 835 is disposed in the middle of the center closed loop portion.

While an impact force is generated at two sides of a magnet in the same direction in FIG. 14, an impact force is generated at four sides of a magnet in the same direction in FIG. 17 and thus a greater impact force may be applied.

FIGS. 16 and 18 are graphs of frequency response functions obtained by performing a modal test by using an acceleration sensor and using the transducers 820 and 830 illustrated in FIGS. 14 and 17 as actuators, respectively. FIGS. 16 and 18 show results of a modal test performed on an aluminum plate that is 500 mm in width and length and 2 mm in thickness. Both of the frequency response functions illustrated in FIGS. 16 and 18 are similar to the frequency response function illustrated in FIG. 10. The results show that the transducers 820 and 830 may excellently function as actuators.

FIG. 19 is a schematic view when a modal test is performed by using the transducer 830 illustrated in FIG. 17 as an actuator and using the transducer 820 illustrated in FIG. 14 as a sensor.

FIG. 20 is a graph of a frequency response function when a modal test is performed as illustrated in FIG. 19.

The frequency response function illustrated in FIG. 20 is also similar to the frequency response function illustrated in FIG. 10. The result shows that a transducer according to an embodiment of the present invention may excellently function as a sensor as well as an exciter (vibrator).

As described above, a modal test of a plate member may be easily performed by using a non-contact type transducer according to the present invention and thus may be accurately performed without errors even when an inexperienced person performs the modal test. Also, the non-contact type transducer according to the present invention may be simply set over a plate member and may excite and measure vibration without contacting the plate member.

Modified examples of the transducers 500, 600, 810, 820 and 830 respectively illustrated in FIGS. 2, 7, 12, 14 and 17 will now be described. Here, the modified examples may be obtained by removing static magnetic field formers, i.e., magnets, from the transducers 500, 600, 810, 820 and 830. Transducers functioning almost the same as the transducers 500, 600, 810, 820 and 830 may be realized even when the static magnetic field formers are removed.

In more detail, if a dynamic magnetic field former is disposed by a distance from a plate member, i.e., a test target, and a power source connected to a multi-loop coil varies a current that flows through the multi-loop coil, an eddy current flows on a surface of the plate member. Due to the eddy current and a magnetic field formed by the dynamic magnetic field former, the Lorentz force is applied to the plate member. Even when a static magnetic field former does not exist, the principal of Lorentz force may be theoretically explained as described below.

For example, in the structure illustrated in FIG. 5, a magnetic flux density formed by a multi-loop coil, i.e., a dynamic magnetic field former, and a magnet, i.e., a static magnetic field former, may be represented by using Equation 1.

B=B^{S}+B^{D}=μ₀μᵣ,H^{S}+μ₀μᵣ,H^{D} [Equation 1]

Here, B represents an overall magnetic flux density, B^{S} represents a static magnetic flux density, B^{D} represents a dynamic magnetic flux density, μ₀ represents a free-space permeability, μᵣ represents a relative permeability, H^{S} represents a static magnetic field, and H^{D} represents a dynamic magnetic field.

In consideration of only an electromagnetic field that varies on the x-z plane, a current density J_{y} of the eddy current generated on the plate member, i.e., a conductor, may be represented by using Equation 2.

$${J}_{y} = \frac{\partial {H}_{x}^{D}}{\partial z} - \frac{\partial {H}_{z}^{D}}{\partial x} \qquad [ Equation 2 ]$$

In the structure illustrated in FIG. 5, since the variance of variables in the z direction is greatly lower than that in the x direction, the size of the Lorentz force applied in the z direction may be represented by using Equation 3.

$${F}_{z} = - ( {B}_{x}^{S} + {B}_{x}^{D} ) \frac{\partial {H}_{x}^{D}}{\partial z} = - ( {μ}_{0} {μ}_{r} {H}_{x}^{S} + {μ}_{0} {μ}_{r} {H}_{x}^{D} ) \frac{\partial {H}_{x}^{D}}{\partial z} \qquad [ Equation 3 ]$$

Here, since the static magnetic flux density B^{S} does not have a value if a permanent magnet does not exist, the Lorentz force applied by the modified examples of the transducers 500, 600, 810, 820 and 830 may be represented by using Equation 4.

$${F}_{z} = - ( {B}_{x}^{D} ) \frac{\partial {H}_{x}^{D}}{\partial z} = - ( {μ}_{0} {μ}_{r} {H}_{x}^{D} ) \frac{\partial {H}_{x}^{D}}{\partial z} \qquad [ Equation 4 ]$$

As shown in Equation 4, even when a static magnetic field former does not exist unlike the transducers 500, 600, 810, 820 and 830, the plate member may be excited by using the principal of EMAT. However, if a static magnetic field former exists, a force is added by a static magnetic field component and thus the plate member may be excited with a greater force.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A transducer comprising:
a multi-loop coil having two or more closed loop portions and disposed above and separate from a plate member; and
a magnet having a neutral plane between north (N) and south (S) poles parallel to a surface of the plate member and functioning as a static magnetic field former,
wherein the plate member is formed of a conductor,
wherein an eddy current that flows on a surface of the plate member is generated by controlling a current that flows through the multi-loop coil, and Lorentz forces are applied in directions perpendicular to the surface of the plate member due to the eddy current and a magnetic field component parallel to the surface of the plate member of a static magnetic field formed by the static magnetic field former, and
wherein an eddy current is generated on regions of the plate member below a magnetic field component parallel to the surface of the plate member of a static magnetic field formed by the static magnetic field former when vibration is transmitted on the plate member, and an electromotive force is generated on the multi-loop coil so that a magnetic field component is formed in a direction opposite to a direction of a magnetic field component formed due to the eddy current in order to offset the magnetic field component formed due to the eddy current, and the vibration transmitted on the plate member is measured from the electromotive force.

2. The transducer of claim 1, wherein the multi-loop coil is a figure-of-8 type coil having two closed loop portions,
wherein the two closed loop portions are disposed in a row above the plate member and parallel to the surface of the plate member, and
wherein the two closed loop portions have different coiling directions.

3. The transducer of claim 1, wherein the multi-loop coil has an odd number of closed loop portions,
wherein an even number of side closed loop portions are symmetrically disposed with respect to one center closed loop portion, and
wherein a coiling direction of the center closed loop portion is different from the coiling direction of the side closed loop portions.

4. The transducer of claim 3, wherein the magnet is disposed in a middle of the center closed loop portion and separate from the plate member, and
wherein the neutral plane of the magnet is parallel to the surface of the plate member.

5. The transducer of claim 1, wherein the multi-loop coil comprises a coil in which figure-of-8 type coils each having two closed loop portions are disposed to cross each other,
wherein the two closed loop portions of each of the figure-of-8 type coils are disposed in a row above the plate member and parallel to the surface of the plate member, and
wherein the two closed loop portions of each of the figure-of-8 type coils have different coiling directions.

6. The transducer of claim 1, wherein the static magnetic field is formed by disposing two or more magnets in a parallel direction to the surface of the plate member with different poles of the magnet facing each other above the plate member.

7. A transducer comprising:
a multi-loop coil having two or more closed loop portions and disposed above and separate from a plate member;
a magnet having a neutral plane between north (N) and south (S) poles parallel to a surface of the plate member and functioning as a static magnetic field former; and
conductor foil attached on the plate member so as to cover a surface portion of the plate member facing the multi-loop coil,
wherein an eddy current that flows on a surface of the conductor foil is generated by controlling a current that flows through the multi-loop coil, and Lorentz forces are applied in directions perpendicular to the surface of the plate member due to the eddy current and a magnetic field component parallel to the surface of the plate member of a static magnetic field formed by the static magnetic field former, and
wherein an eddy current is generated on the conductor foil contacting regions of the plate member below a magnetic field component parallel to the surface of the plate member of a static magnetic field formed by the static magnetic field former when vibration is transmitted on the plate member, and an electromotive force is generated on the multi-loop coil so that a magnetic field component is formed in a direction opposite to a direction of a magnetic field component formed due to the eddy current in order to offset the magnetic field component formed due to the eddy current, and the vibration transmitted on the plate member is measured from the electromotive force.

8. The transducer of claim 7, wherein the multi-loop coil is a figure-of-8 type coil having two closed loop portions,
wherein the two closed loop portions are disposed in a row above the plate member and parallel to the surface of the plate member, and
wherein the two closed loop portions have different coiling directions.

9. The transducer of claim 7, wherein the multi-loop coil has an odd number of closed loop portions,
wherein an even number of side closed loop portions are symmetrically disposed with respect to one center closed loop portion, and
wherein a coiling direction of the center closed loop portion is different from the coiling direction of the side closed loop portions.

10. The transducer of claim 9, wherein the magnet is disposed in a middle of the center closed loop portion and separate from the plate member, and
wherein the neutral plane of the magnet is parallel to the surface of the plate member.

11. The transducer of claim 7, wherein the multi-loop coil comprises a coil in which figure-of-8 type coils each having two closed loop portions are disposed to cross each other,
wherein the two closed loop portions of each of the figure-of-8 type coils are disposed in a row above the plate member and parallel to the surface of the plate member, and
wherein the two closed loop portions of each of the figure-of-8 type coils have different coiling directions.

12. The transducer of claim 7, wherein the static magnetic field is formed by disposing two or more magnets in a parallel direction to the surface of the plate member with different poles of the magnet facing each other above the plate member.

13. A transducer comprising:
a multi-loop coil having two or more closed loop portions and disposed above and separate from a plate member; and
a power source for applying a variable current signal to the multi-loop coil,
wherein the plate member is formed of a conductor, and
wherein an eddy current that flows on a surface of the plate member is generated by controlling a current that flows through the multi-loop coil, and Lorentz forces are applied in directions perpendicular to the surface of the plate member due to the eddy current and a magnetic field component parallel to the surface of the plate member of a static magnetic field formed by the static magnetic field former.

14. The transducer of claim 13, wherein the multi-loop coil is a figure-of-8 type coil having two closed loop portions,
wherein the two closed loop portions are disposed in a row above the plate member and parallel to the surface of the plate member, and
wherein the two closed loop portions have different coiling directions.

15. The transducer of claim 13, wherein the multi-loop coil has an odd number of closed loop portions,
wherein an even number of side closed loop portions are symmetrically disposed with respect to one center closed loop portion, and
wherein a coiling direction of the center closed loop portion is different from the coiling direction of the side closed loop portions.

16. The transducer of claim 13, wherein the multi-loop coil comprises a coil in which figure-of-8 type coils each having two closed loop portions are disposed to cross each other,
wherein the two closed loop portions of each of the figure-of-8 type coils are disposed in a row above the plate member and parallel to the surface of the plate member, and
wherein the two closed loop portions of each of the figure-of-8 type coils have different coiling directions.

17. A transducer comprising:
a multi-loop coil having two or more closed loop portions and disposed above and separate from a plate member;
a power source for applying a variable current signal to the multi-loop coil; and
conductor foil attached on the plate member so as to cover a surface portion of the plate member facing the multi-loop coil,
wherein an eddy current that flows on a surface of the conductor foil is generated by controlling a current that flows through the multi-loop coil, and Lorentz forces are applied in directions perpendicular to the surface of the plate member due to the eddy current and a magnetic field component parallel to the surface of the plate member of a static magnetic field formed by the static magnetic field former.

18. The transducer of claim 17, wherein the multi-loop coil is a figure-of-8 type coil having two closed loop portions,
wherein the two closed loop portions are disposed in a row above the plate member and parallel to the surface of the plate member, and
wherein the two closed loop portions have different coiling directions.

19. The transducer of claim 17, wherein the multi-loop coil has an odd number of closed loop portions,
wherein an even number of side closed loop portions are symmetrically disposed with respect to one center closed loop portion, and
wherein a coiling direction of the center closed loop portion is different from the coiling direction of the side closed loop portions.

20. The transducer of claim 17, wherein the multi-loop coil comprises a coil in which figure-of-8 type coils each having two closed loop portions are disposed to cross each other,
wherein the two closed loop portions of each of the figure-of-8 type coils are disposed in a row above the plate member and parallel to the surface of the plate member, and
wherein the two closed loop portions of each of the figure-of-8 type coils have different coiling directions.
